(19) United States
(12) Patent Application Publication
(10) Pub. No.: US 2005/0175119 A1
(43) Pub. Date: Aug. 11, 2005

(54) Forward link quality link monitoring apparatus and method

(76) Inventors: David A. Worley, Federal Way, WA (US); Alan M. Sweeney, Oceanside, CA (US)

Correspondence Address: HARNESS, DICKEY & PIERCE, P.L.C., P.O. BOX 828, BLOOMFIELD HILLS, MI, 48303, US

(21) Appl. No.: 10/775,771

(22) Filed: Feb. 9, 2004

(51) Int. Cl. H04L 27/06

(52) U.S. Cl. 375/316

(57) ABSTRACT

A system and method for accurately determining Eb/No information for a signal transmitted by a second communications station, via electromagnetic wave signals, to a first communications station. The system involves a noise generating subsystem for generating a known quantity of noise that is applied to the received signal to create a composite signal. Signal attenuators are used to define a known operating point for the composite signal. A receiver at the first communications station monitors the signal and provides a downlink loss representative of rain attenuation affecting the signal. A demodulator generates an Eb/No value of the composite signal which is then output to a computer. The computer extrapolates, from the composite signal and the downlink loss, a highly accurate Eb/No value which is not influenced by atmospheric conditions or by losses introduced by signal components of the system itself.

### FIELD OF THE INVENTION

The present system relates to systems for monitoring the quality of electromagnetic wave signals being received at a receiving station, and more particularly to a system and method that compensates for noise levels and transmission losses affecting an electromagnetic wave signal transmitted from a satellite transponder to a receiving communications station.

### BACKGROUND OF THE INVENTION

The CONNEXION BY BOEING^{SM} system, in one preferred implementation, involves the use of a satellite based transponder for transponding information transmitted in electromagnetic wave form between a mobile platform, such as a jet aircraft, and a communications station. In this preferred implementation form, the communications station is a ground based transceiver station.

With the CONNEXION BY BOEING system^{SM}, or with any system requiring information to be transmitted (i.e., uplinked) to a satellite based transponder, it is highly desirable to monitor the quality of the transmission from the communications station to the satellite based transponder. For discussion purposes, this transmission will be termed the “forward link”. By using the satellite based transponder to transpond this signal within a given coverage region and then using the ground station to receive the transponded signal and to monitor the quality of this signal (i.e., the “transponded forward link signal”), any deterioration or interruption of the forward link signal can be quickly identified. In addition, suitable corrective action can be taken by individuals working with the communications station. Accordingly, using the ground based communications station to monitor the quality of the transponded forward link signal from the satellite based transponder allows real time monitoring and correction of any system anomalies that could affect the quality of the forward link signal actually being sent by the satellite based transponder.

One factor, however, that can affect the accuracy of the signal quality information generated by the communication system from the transponded forward link signal is atmospheric conditions, and specifically rain induced signal attenuation. The system noise associated with components at the communications station also may have a negative effect on the accuracy of the signal quality information reported by the communications station. This is particularly so if the information being received by the communications station is a relatively low power signal. In such instances, atmospheric induced transmission losses, as well as losses or aberrations in the received, transponded forward link signal caused by physical components of the communications station, could significantly negatively impact the accuracy of signal quality measurements being made on the transponded forward link signal from the satellite based transponder. In some instances, weather induced (i.e,. particularly rain) attenuation could potentially modulate the transponded forward link signal received by the communications station virtually decibel per decibel.

Accordingly, it is highly desirable to provide some means for correcting for atmospheric induced transmission losses, as well as losses induced by components associated with the communications station, to enable the communications station to accurately monitor and generate information relating to the signal quality of the transponded forward link signal from the satellite based transponder, as it is received by the communications station. This would provide the operators at the communications station with a high degree of confidence that the output of satellite based transponder is being maintained at a desired signal quality and/or power level.

### SUMMARY OF THE INVENTION

A system and method for correcting for noise levels and transmission losses affecting information transmitted from a second communications station to a first communications station. In one preferred form the second communications station comprises a satellite based transponder, and the first communications station comprises a terrestrial based communications station.

The system and method involves utilizing a noise source and adding a known quantity of noise to an electromagnetic wave signal received from the second communications station. The signal received from the second communications station may be affected by unfavorable atmospheric conditions such as rain, snow, etc. The signal could also be affected by losses introduced by components associated with the first communications station. The known quantity of noise is added to the received signal to create a composite signal. The noise is selected such that a known operating point for the signal is created. A signal receiver associated with the first communications station is used to monitor for the transmission loss being experienced by the signal. A computer is then used to receive signal quality information from the signal receiver, and from this information, in connection with the known operating point, the degree of noise added, and the composite signal, to extrapolate highly accurate signal quality information for the signal being transmitted by the second communications station.

In one preferred implementation, the highly accurate signal quality information comprises highly accurate Eb/No (energy per bit/noise spectral density) information pertaining to the signal transmitted from the second communications system to the first communications system.

In one specific implementation, the present system and method involves the use of separate signal combiners and separate signal attenuators for processing either horizontally polarized or vertically polarized signal components of the signal being received by the first communications station. In this implementation, an L-band oscillator is used in connection with a noise source to provide a noise signal over the L-band frequency range.

The apparatus and method enables the signal quality information to be transmitted from a remote communications station, such as a satellite based transponder, to a different communications station without the negative affects of losses induced by atmospheric conditions and/or physical components of the receiving communications station. As a result, highly accurate signal quality information can be produced that is free of the negative affects of changing atmospheric conditions and/or changing thermal equipment affects. This signal quality information provides operators associated with the ground station a much more accurate indication of the signal quality of the signal being generated at the transponder's output.

Further areas of applicability of the present invention will become apparent from the detailed description provided hereinafter. It should be understood that the detailed description and specific examples are intended for purposes of illustration only and are not intended to limit the scope of the invention.

### BRIEF DESCRIPTION OF THE DRAWINGS

The present system will become more fully understood from the detailed description and the accompanying drawings, wherein:

FIG. 1 is a block diagram of a system for providing highly accurate signal quality information; and

FIG. 2 is a flow chart illustrating the major steps of operation performed in one preferred implementation of the present system.

### DETAILED DESCRIPTION OF THE PREFERRED EMBODIMENTS

The following description of the preferred embodiment(s) is merely exemplary in nature and is in no way intended to limit the system, its application, or uses.

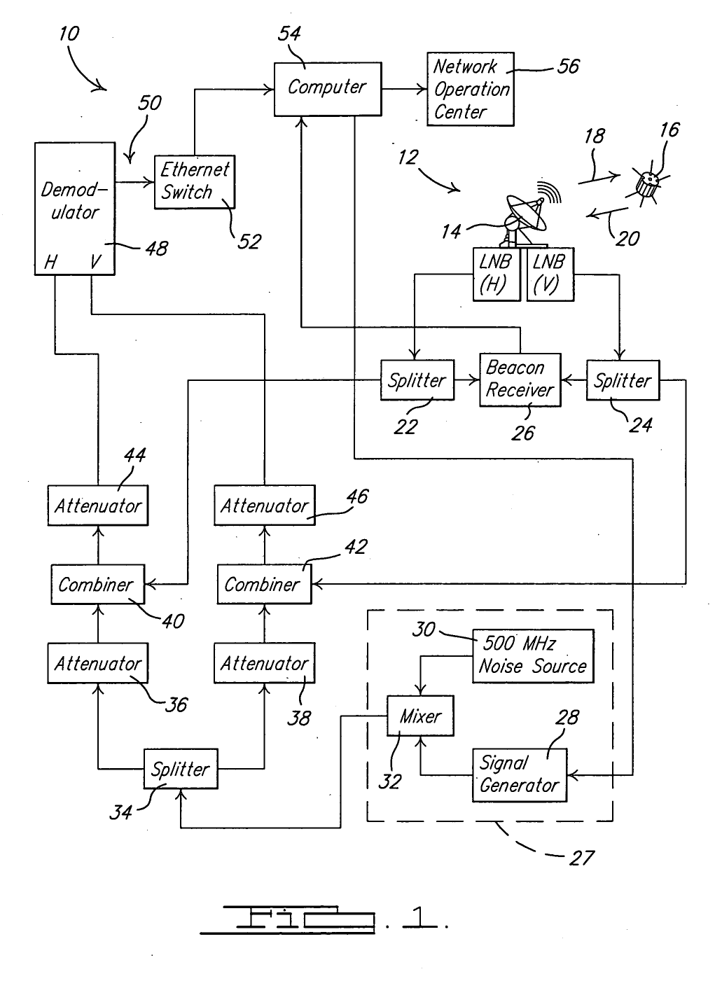

Referring to FIG. 1, there is shown one preferred system 10 for providing highly accurate signal quality information. While the present system will be described in connection with the use of a satellite based transponder and a terrestrial receiving communications station, it will be appreciated that the principles discussed herein could just as readily be implemented between two airborne communication stations, between two terrestrial based communication stations, or any combination of airborne, sea-based and ground based communication stations. Essentially, any application where electromagnetic wave energy needs to be transmitted through the atmosphere or to/from mobile platforms operating above and/or under water, and where atmospheric conditions and/or electronic components themselves may introduce transmission losses or otherwise affect the quality of received electromagnetic wave signals, is anticipated as being within the scope of the present system. Therefore, reference to a satellite based transponder and a terrestrial based receiving communications system should be understood as being merely for exemplary purposes.

The system 10, in one preferred implementation, involves using a first communications station 12, in this example a terrestrial based communications station 12 having an antenna 14, to transmit information in electromagnetic wave form to a satellite based transponder 16 that forms a second communications station. This transmission is viewed as a “forward link” signal 18. The satellite based transponder 16 receives this forward link signal and transmits (i.e., “transponds”) it to various mobile platforms operating within a given coverage region. This signal will be referred to as the “transponded forward link” signal 20. In this regard, it is highly desirable that the forward link signal 18 be of sufficient magnitude to maintain the satellite based transponder 16 in a saturated condition to maximize overall system efficiency. In this manner, the transponded forward link signal 20 will be delivered most efficiently to the mobile platforms.

Because the transponded forward link signal 20 is typically of a much lower power level than the forward link signal 18 (often 10 times-20 times lower), the transponded forward link signal 20 is much more susceptible to being negatively influenced by atmospheric conditions such as rain, snow, etc. as it is received by the mobile platforms and the terrestrial communications station 12. Rain, in particular, can significantly attenuate and otherwise negatively influence the forward link 18 signal. The transponded forward link 18 signal received by the terrestrial station 12 can also be negatively affected by residual noise present in various electronic components being used to process the signals received by the terrestrial communications station 18. As a result, the Eb/No information derived via the transponded forward link signal 18 can be significantly influenced by atmospheric conditions, as well as by noise in various electronic components that are used to process this information.

Referring further to FIG. 1, the system 10 further includes a signal splitter 22 for receiving a horizontally polarized, transponded forward link signal 20, and a signal splitter 24 for receiving a vertically polarized, transponded forward link signal 20. Thus, the system 10 can accommodate either form of polarization for the transponded forward link signal 20. Typically, signals of one form of polarization or the other will be employed. Each of the splitters 22 are used to split their respectively received signals and to provide outputs to a beacon receiver 26. The beacon receiver 26 is used to determine atmospheric induced losses affecting the transponded forward link signal 20. These atmospheric losses will be referred to as “down link” losses. In this regard, it will be appreciated that satellite transponders typically incorporate either a separate beacon signal generating component, or a separate telemetry, command and control (“TCC”) return signal, neither of which are directly associated with the forward link signal 20. Either of these signals are ideally suited for monitoring downlink signal attenuation.

With further reference to FIG. 1, a noise generating system 27 is provided for introducing a known quantity of noise into the transponded forward link signal 20 after it is received by the terrestrial communications station. The system 27 includes a signal generator 28, a noise source 30 and a mixer 32. Noise source 30, in one implementation, comprises a 500 MHz bandwidth noise signal. Signal generator 28, in one preferred implementation, comprises an L-band local oscillator that is able to translate the 500 MHz noise source 30 to the 950 MHz-1450 MHz L-band spectrum.

Mixer 32 provides the L-band noise output to a signal splitter 34, which in turn splits the known quantity of noise generated by the system 27 for output to each of a pair of attenuators 36 and 38. The attenuators 36 and 38 enable precise level setting of the noise signal output by splitter 34 relative to the received signal level.

Attenuator 36 feeds a signal combiner 40 and attenuator 38 feeds a signal combiner 42. Signal combiner 40 also receives an output from splitter 22, which would be a portion of a received, horizontally polarized, transponded forward link signal 20. Similarly, signal combiner 42 receives an output from signal splitter 24, which would be a portion of a received, vertically polarized, transponded forward link signal 20. Each of these signal combiners 40 and 42 combine the two inputs being received to produce an output which is applied to signal attenuators 44 and 46, respectively. Signal attenuators 36 and 38 are used to precisely define an operating point for a composite signal that is applied to a demodulator 48. The term “operating point”, more specifically, refers to a specific signal-to-noise mix that results in a specific signal-to-noise ratio or specific Eb/No value. Each of attenuators 44 and 46 essentially set the level of the composite signal into the demodulator 48.

The outputs from attenuators 44 and 46 are provided to the horizontal and vertical polarization inputs, respectively, of a demodulator 48 which provides an output 50 representative of a composite signal quality value having the known quantity of noise and the known operating point. In one preferred implementation the demodulator 48 comprises a Forward Receive Demodulator. The signal quality output 50 of the demodulator 48 may be applied via an Ethernet switch 52 or other suitable interfacing component to an input of a computer 54.

With further reference to FIG. 1, the computer 54 also receives on an input thereof an output from the beacon receiver 26 representing the downlink signal loss affecting the transponded forward link signal 20. It will be appreciated that the output of the beacon receiver 26 is a real time output, and that the beacon receiver monitors the downlink signal loss in real time. The computer 54 takes the composite signal quality output of the demodulator 48, taking into consideration the known operating point, the downlink loss provided by the beacon receiver 26, and the known quantity of noise added by the noise generating subsystem 27, and determines highly accurate Eb/No information that can be reported to a network operations center 56. The network operations center 56 uses the accurate Eb/No information in monitoring the quality of the forward link signal 18. Since this monitoring is done in real time, any condition affecting the quality of the transponded forward link signal can be quickly addressed and corrective action taken if needed. Also importantly, real time monitoring of the Eb/No value of the transponded forward link signal 20, together with the Eb/No compensation performed by the computer 54, allows very accurate, real time monitoring of the signal quality available at the output of the satellite based transponder 16.

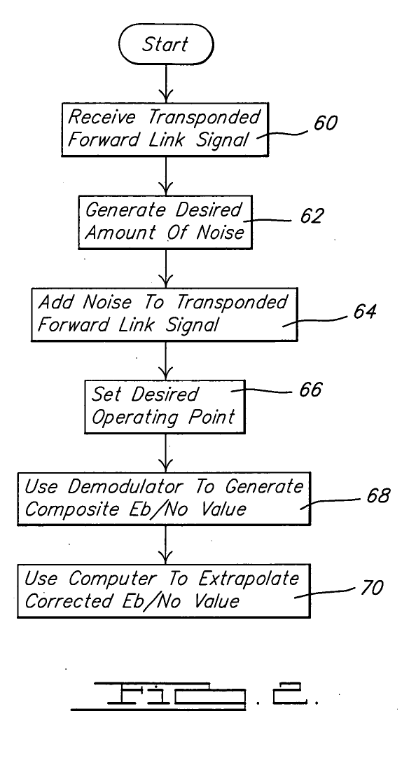

Referring to FIG. 2, a simplified flow chart of the steps of operation implemented by the system 10 is shown. Initially, at operation 60, the transponded forward link signal 20 is received. In operation 62, a desired degree of noise is generated. In operation 64, the desired degree of noise is added to a portion of the transponded forward link signal 20. In operation 66, a desired operating point for the intermixed noise and received transponded forward link signal 20 is set and a composite signal is generated. For example, the operating point may be set for a clear sky Eb/No reading of 15 decibels (dB). The term “clear sky”, in this instance, represents an Eb/No reading that would have been obtained during prior testing of the system under clear atmospheric conditions.

In operation 68, the demodulator 48 is used to generate an Eb/No value for the composite signal. In operation 70, the composite Eb/No value is used by the computer 54 to extrapolate a corrected Eb/No signal value that takes into account the down link loss reported by beacon receiver 26, as well as any losses introduced by the various components of the system 10. Essentially, the computer adds the absolute value, in dB, of the downlink loss to the Eb/No value provided by the demodulator 48 to produce the final, corrected Eb/No value. The final, corrected Eb/No value thus takes into effect the downlink loss caused by rain attenuation or any other atmospheric conditions, that are operating to attenuate the transponded forward link signal 20 as it is received by the terrestrial communications station 12.

The system 10 thus forms a means for compensating for atmospheric and other system related losses that affect the Eb/No information gleaned from the transponded forward link signal 20. In this manner the performance of the forward link signal 18 can be closely monitored with confidence that the transponded forward link signal 20 generated by the satellite based transponder 16 is at a level suitable for excellent reception by the mobile platforms. The system 10 thus essentially removes the influence of the atmosphere and of the various components of the system itself from the transponded forward link signal 20.

While various preferred embodiments have been described, those skilled in the art will recognize modifications or variations which might be made without departing from the inventive concept. The examples illustrate the system and are not intended to limit it. Therefore, the description and claims should be interpreted liberally with only such limitation as is necessary in view of the pertinent prior art.

1. A method for detecting and correcting for losses influencing a signal being radiated, in electromagnetic wave form, to a first communications station from a second communications station, to provide a more accurate signal quality value determination of said signal, said method comprising:
using said first communications station to receive said signal transmitted from said second communications station;
adding a quantity of noise to said signal received by said first communications station to produce a composite signal having a known operating point;
monitoring a beacon signal from said second communications station to determine a transmission loss affecting said signal as said signal is transmitted from said second communications station to said first communications station; and
using said transmission loss, said quantity of noise and said composite signal to extrapolate a signal quality value for said signal transmitted by said second communications station.

2. The method of claim 1, wherein using said first communications station to receive said signal comprises transmitting said signal from a satellite based transponder to said first communications station.

3. The method of claim 1, wherein using said first communications station to receive said signal comprises using a terrestrial based communications station to receive said signal.

4. The method of claim 1, wherein adding a quantity of noise comprises adding a quantity of noise having a frequency within a range of between about 950 MHz-1450 MHz.

5. The method of claim 1, wherein monitoring said beacon signal comprises using a beacon receiver to monitor said beacon signal to determine therefrom downlink losses of said signal for use in determining said signal quality value.

6. The method of claim 1, wherein an absolute value of said transmission loss is used in determining said signal quality value.

7. A method for detecting and correcting for atmospheric losses influencing an Eb/No value of an information signal being radiated, in electromagnetic wave form, to a communications station from a satellite based transponder, to provide a more accurate Eb/No value determination of said signal, said method comprising:
using said communications station to receive said information signal transmitted from said satellite based transponder;
adding a quantity of noise to said information signal received by said first communications station to produce a composite signal having a known operating point;
determining a composite Eb/No value from said composite signal;
monitoring a beacon signal from a satellite associated with said satellite based transponder to determine a transmission loss affecting said information signal caused by atmospheric conditions, and generating a downlink loss value representative of said transmission loss; and
using said downlink loss value, said quantity of noise and said composite signal to extrapolate a corrected Eb/No value, said corrected Eb/No value having an influence of an atmospheric loss removed therefrom.

8. The method of claim 7, wherein adding a quantity of noise comprises adding a quantity of noise having a frequency within a range of between about 950 MHz-1450 MHz.

9. The method of claim 7, wherein using said communications station comprises using a terrestrial based station to receive said information signal.

10. The method of claim 7, wherein extrapolating said corrected Eb/No value comprises using a computer to determine said corrected Eb/No value.

11. A method for compensating for losses affecting a signal being transmitted, in electromagnetic wave form, from a second communications station to remotely located first communications station, the method comprising:
adding a known quantity of noise to a signal transmitted from said second communications station and received by said first communications station;
determining an aggregate loss affecting an accuracy of a Eb/No measurement of said signal; and
using said known quantity of noise and said aggregate loss to determine a corrected Eb/No value for said signal.

12. The method of claim 11, wherein determining an aggregate loss comprises determining an atmospheric induced loss affecting said signal.

13. The method of claim 11, wherein determining an aggregate loss comprises determining a loss induced by receiving equipment of said first communications station.

14. The method of claim 11, wherein inducing a known quantity of noise comprises inducing noise having a frequency of between about 950 MHz-1450 MHz.

15. The method of claim 11, wherein determining said corrected Eb/No value comprises using a computer to determine said corrected Eb/No value.

16. The method of claim 11, wherein determining an aggregate loss comprises using a beacon receiver to receive a beacon signal from said second communications station and determining therefrom a magnitude of atmospheric induced loss affecting said signal.

17. A system for correcting for losses affecting a signal being transmitted, in electromagnetic wave form, from a second communications station to a first communications station, comprising:
a subsystem for generating a known quantity of noise to be added to a signal transmitted from said second communications station;
a combiner for combining said known quantity of noise with said signal to produce a composite signal;
an attenuator for receiving said composite signal and defining a known operating point for said composite signal;
a receiver for monitoring a downlink loss affecting said signal; and
a computer for using said quantity of noise, said composite signal, said downlink loss and said operating point to extrapolate a signal quality value, said signal quality value representing a measurement of a quality of said signal having said losses removed therefrom.

18. The system of claim 17, wherein said subsystem for generating a known quantity of noise comprises a noise source for generating a noise signal having a frequency between about 950 MHz-1450 MHz.

19. The system of claim 18, wherein said subsystem for generating a known quantity of noise further comprises a local oscillator and mixer.

20. The system of claim 17, wherein said first communications station generates said signal as comprised of one of a horizontally polarized signal component and a vertically polarized signal component.

21. The system of claim 20, further comprising a splitter for splitting said known quantity of noise such that a sub quantity of said noise is separately applied to each of said horizontally and vertically polarized signal components of said signal.

22. The system of claim 20 further comprising a separate attenuator for each of said vertically and horizontally polarized signal components, for defining said known operating point.

23. The system of claim 17, further comprising a signal splitter for dividing said signal into a first component and a second component, said first component being input to said receiver.

24. The system of claim 23, wherein said second component is input to said combiner to be combined with said known quantity of noise.

25. The system of claim 17, further comprising a demodulator responsive to said known quantity of noise and said composite signal for generating said signal quality value.
